(19) United States
(12) Patent Application Publication
(10) Pub. No.: US 2026/0147101 A1
(43) Pub. Date: May 28, 2026

(54) Use of Time-Integrated Samples of Return Waveforms to Enable a Software Defined Continuous Wave Lidar

(71) Applicant: PreAct Technologies, Inc., Portland, OR (US)

(72) Inventors: Lance SAFRANEK, Portland, OR (US); JiaHsuan LO, Portland, OR (US); Paul DRYSCH, Portland, OR (US); James DAWSON, Portland, OR (US)

(21) Appl. No.: 18/963,478

(22) Filed: Nov. 27, 2024

Related U.S. Application Data
(63) Continuation of application No. PCT/US23/24020, filed on May 31, 2023.
(60) Provisional application No. 63/347,482, filed on May 31, 2022.

(51) Int. Cl. G01S 7/4915; G01S 17/86; G01S 17/894; G06T 7/292

(52) U.S. Cl. CPC G01S 7/4915; G01S 17/86; G01S 17/894; G06T 7/292; G06T 2207/10028; G06T 2207/20221

(57) ABSTRACT

Example non-limiting technology herein provides several specific approaches for making CWTOF lidar more flexible and amendable to waveform controls. A first method examines how different mathematical wave models can be applied to the continuous wave approach to increase accuracy and reduce calibration burden. Second, an example is described of how carrier waveforms can be modulated with the continuous waveform and then demodulated prior to summation in order to improve noise rejection from both environmental and electronic sources. Third, an example is presented of how DCS frames can be updated with every sample rather than every 5th sample as commonly done (4 DCS frames and 1 ambient frame), which is especially advantageous for tracking faster objects. Fourth, an example of post-collection DCS frame signal processing is given that significantly reduces temporal noise. Fifth, a method is shown for using alternate frames at different integration times to significantly increase the dynamic range of the system. Sixth, an approach for integrating data from the CWTOF lidar with data from an amplitude map (e.g. B&W camera) can be used to form and track objects.

### CROSS-REFERENCE TO RELATED APPLICATIONS

This application is a continuation of PCT Application No. PCT/US2023/24020 filed May 31, 2023, which claims the benefit of U.S. Provisional Patent Application No. 63/347,482 filed May 31, 2022. These applications are incorporated herein by reference in their entireties and for all purposes.

### FIELD

The technology herein relates to Software Defined Systems (SDSs) for Light Detection and Ranging (LIDAR), and more particularly to SDS approaches for making Continuous Wave Time of Flight (CWTOF) lidar more flexible and amendable to waveform controls.

### BACKGROUND

### Software Defined Systems

Software defined systems are devices that emit a waveform in the electromagnetic or acoustic spectra, and modify that waveform and how it is processed to achieve different performance metrics. The most common example of a software defined system is a Software Defined Radio (SDR), where the typical hardware used to create a waveform and/or process its return is replaced by digital approaches. For example, a Digital to Analog Converter (DAC) may replace special purpose mixers, filters and modulators in creating the output signal, and paired detectors, filters, and demodulators may be replaced, in part or entirely, by an Analog to Digital Converter (ADC) system. The same approach can and has been applied to other fields such as Lidar, often called a Software Defined Lidar (SDL). All software defined systems to date share the attribute of sampling the waveform as it returns, and comparing it in detail with a reference wave as emitted.

### Overview of Software Defined Continuous Wave Lidar Approaches

A Continuous Wave Lidar (CWL), often called a Continuous Wave Time of Flight (CWTOF) sensor, also samples the returning waveform, but it does so in a manner unique from SDL. The emitted signal is always a periodic wave of constant frequency and amplitude. The returning signal is sampled at a specific time per period, relative to a reference wave, over some integration time of many periods. The process is then repeated a limited number of times (typically 4 total in one example implementation) with a time offset so that the integrated signal return is sampled at different locations within a period. These samples, which at least one manufacturer refers to as a “differential correlation sample” (DCS) frame, can then be used to determine the amplitude of the returning wave, the phase difference between it and a reference emitting wave, and the level of ambient light that was added to the return wave from outside sources such as the sun. Since the samples are integrated before they are output, any deviation in periodicity, waveshape or amplitude would simply blur mathematical approaches to determine these waveform characteristics.

Given its standard operation with limited access to the waveform, a CWL would seem a poor candidate from which to create a SDL; however, there are still many analytical approaches that can be used to extend the utility of a given CWL hardware set using software-defined techniques. One may refer to such a device as a Software Defined Continuous Wave Lidar (SDCWL).

There are many CWL sensors on the market today, and software plays an integral part in their usage. Common CWL software functions include:
Calibration—Adjusting phase outputs at the pixel level given different ambient light conditions and sampling frequencies.
Ambient light correction—Methods for using “frames” (single period samples) with no added illumination that record only ambient light to select correct calibration parameters.
Phase difference calculation—Mathematical model for recreating waveform given small number of samples of DCS frames and accumulated over entire integration time.
Pixel binning—Method for combining neighboring pixel returns typically used for modifying sample speed as a function of resolution.
Dynamic range adjustment—Method for using different sets of pixels at different integration times to increase dynamic range of returns.

The above functions result in an array of phase shifts per pixel that must still be converted to a 3D point cloud. In this conversion, one behavior that must be managed is that the phase can only shift 180 degrees before it would “wrap,” meaning the same phase can return multiple ranges, a condition known as “range indeterminacy.” While there are well-known methods for resolving this issue, they require additional time and waveform control, and are thus used infrequently for most applications. This tends to range limit most CWLs to near-field returns where high amplitude returns are assumed to be at the closest range solution, sometimes called the “unambiguous range.” Another factor limiting maximum range is that most CWTOF sensors illuminate the entire field of view (FOV) when collecting a DCS frame. Given the typical requirement for eye safety, practical FOVs tend to limit ranges to no more than 30 meters. Another issue with point cloud generation is the challenge of multi-range returns per pixel due to multiple ranges within the FOV of a single pixel. Range resolution of any Lidar is theoretically limited to pulse width, and since this is relatively long for CWLs, pixels viewing multiple ranges will tend to average the results based on actual range, size and reflectivity of the objects as captured within the pixel sample.

All Lidar types are challenged by low reflectivity targets. CWLs have the advantage of accumulating light over many samples as determined by the integration time, however this also raises the light collected from pixels viewing higher reflectivity objects, which increases the probability of saturation for those objects. In fact, saturation is the converse challenge of low light levels, since a CWL will not return a correct phase value for a saturated pixel. The most challenging saturation situation is normally presented by retroreflectors, which are objects such as headlamps and street signs that are designed specifically to return all light striking it back to its source. These types of objects can create light flux values that are orders of magnitude greater than neighboring Lambertian reflectors.

The converse challenge of low reflectivity targets is those who reflectivity is so great compared with other objects as to cause sensor pixels to saturate. At that point, most information related to range is lost. In addition, optical signal can diffuse to neighboring pixels given non-ideal optics, and electronic signal noise can interfere with electronics related to neighboring pixels.

### SUMMARY

The example non-limiting technology herein provides several specific approaches for making CWTOF lidar more flexible and amendable to waveform controls, which is the hallmark of software defined systems. A first method examines how different mathematical wave models can be applied to the continuous wave approach to increase accuracy and reduce calibration burden. Second, an example is described of how carrier waveforms can be modulated with the continuous waveform and then demodulated prior to summation in order to improve noise rejection from both environmental and electronic sources. Third, an example is presented of how DCS frames can be updated with every sample rather than every 5th sample as commonly done (4 DCS frames and 1 ambient frame), which is especially advantageous for tracking faster objects. Fourth, an example of post-collection DCS frame signal processing is given that significantly reduces temporal noise. Fifth, a method is shown for using alternate frames at different integration times to significantly increase the dynamic range of the system. Sixth, and finally, an approach for integrating data from the CWTOF lidar with data from an amplitude map (e.g. B&W camera) can be used to form and track objects.

### BRIEF DESCRIPTION OF THE DRAWINGS

FIG. 1 is a block diagram of a typical calibration approach.

FIG. 2 shows calibration corrections required for adjusting an arctan 2 waveform model.

FIG. 3 shows an estimated des wave (6 mhz) compared to cosine and

triangle waves.

FIG. 4 shows an example non-limiting point cloud of a flat surface using arctan 2 with no sensor calibration.

FIG. 5 shows an example non-limiting point cloud of a flat surface using arcdiamond2 with no sensor calibration.

FIG. 6 shows an example non-limiting block diagram of a range calculation using arcdiamond2. The point cloud generated using this diagram will look unusually accurate for any sensor and any modulation frequency using a nearly triangular waveform given no calibration. Offset calculation involves two parameters (which were fit to experiments).

FIG. 7 shows an example non-limiting a 3D point cloud developed using arctan 2 approach with significant sensor calibration.

FIG. 8 shows an example non-limiting 3D point cloud developed using arcdiamond2 approach with no sensor calibration.

FIG. 9 shows example Arctan 2 and Arcdiamond2 errors at 24 MHz.

FIG. 10 shows example Arctan 2 and Arcdiamond2 errors at 12 MHz.

FIG. 11 shows example Arctan 2 and Arcdiamond2 errors at 6 MHz.

FIG. 12 shows an example uncalibrated ground generated from arctan 2 (12 mhz).

FIG. 13 shows an example uncalibrated ground generated from arcdiamond2 (12 mhz).

FIG. 14 shows an example uncalibrated ground generated from arctan 2 with correction applied (12 mhz).

FIG. 15 shows an example uncalibrated ground generated from arcdiamond2 with correction applied (12 mhz).

FIG. 16 shows an example normal flow of CWTOF signal processing.

FIG. 17 shows an example CWTOF signal processing with filtering performed before phase calculation.

FIG. 18 shows an example high integration time resulting in saturated areas.

FIG. 19 shows an example low integration time resulting in dark areas with little data.

FIG. 20 shows how an example close-in saturated pixels can distort image.

FIG. 21 shows how an example thresholding method can remove saturated areas but leave gaps.

FIG. 22 shows how even close up, low integration times reduce the visible region and creates noisy areas.

FIG. 23 shows an example non-limiting dual integration time flowchart.

FIG. 24 shows an example non-limiting feedback control loop.

### DETAILED DESCRIPTION OF NON-LIMITING EMBODIMENTS

### Alternate Approaches for Modeling Continuous Waves

### Summary

Since a CWTOF sensor samples an incoming waveform repeatedly at the same phase for a reference signal, the shape of waveform determines the mathematical approach used to convert sampled amplitude measurements into a phase difference.

### Current Method

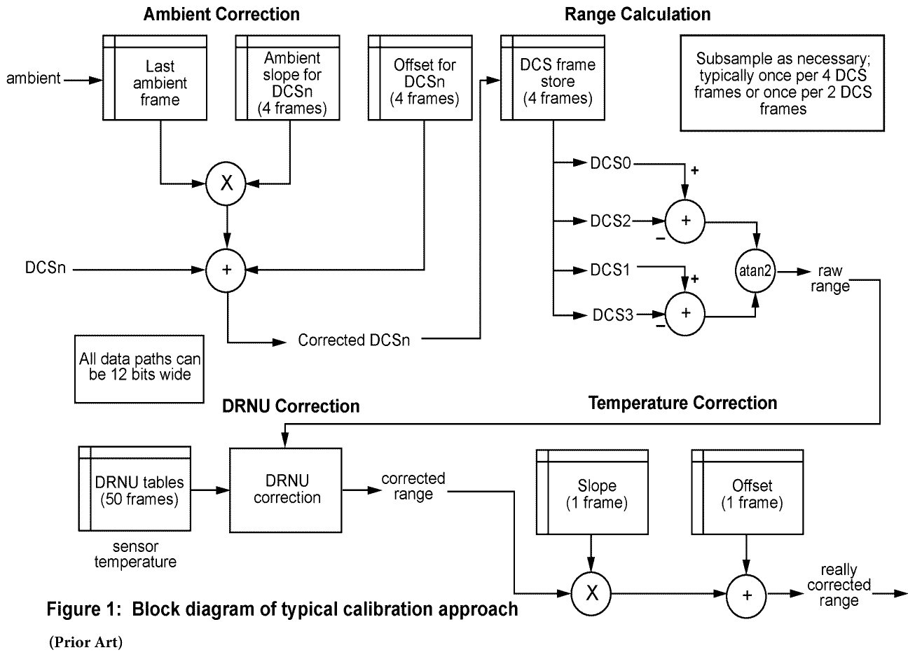

Common manufacturer documentation assumes the observed DCS frames take the form of a cosine function. This assumption has the geometric implication that the calculated phases (via arctangent) reside on a circle. FIG. 1 is a block diagram of a prior art calibration technique.

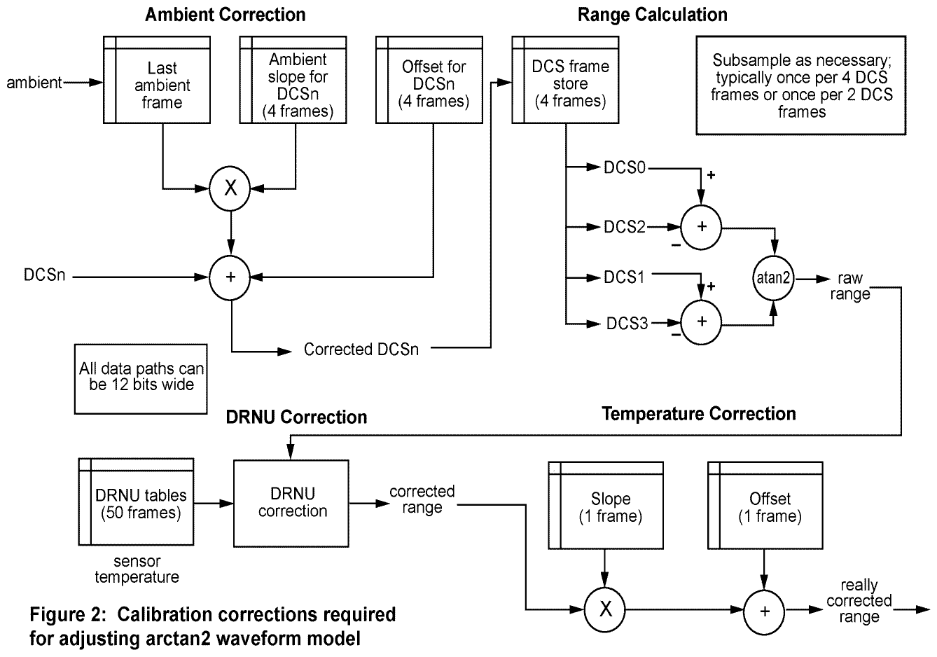

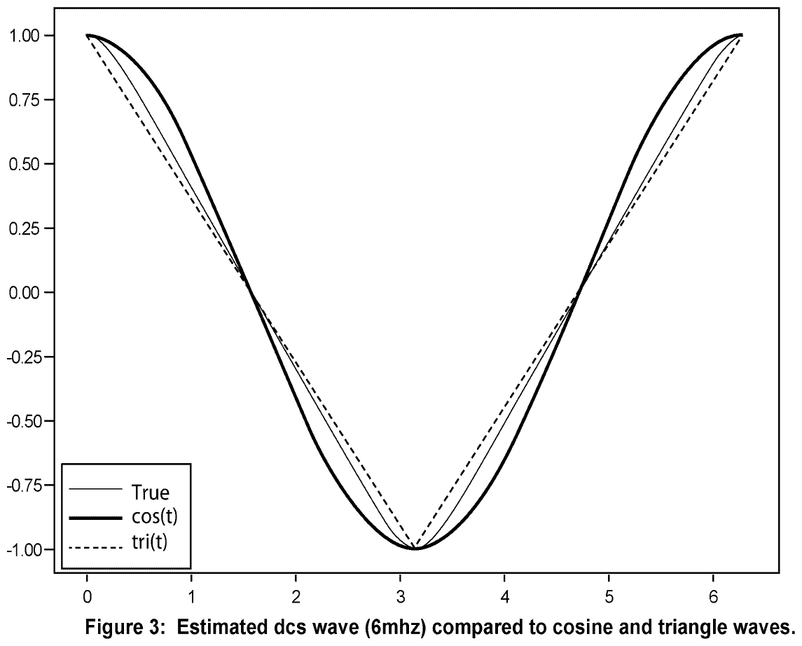

FIG. 2 in contrast is a block diagram of calibration corrections used to adjust arctan 2 waveform models. The true shape is closer to that of a diamond with edge variations as shown in FIG. 3. To calibrate the sensor, the difference between these two shapes is normally computed and stored.

The choice of this approximation has implications of how to compute phase and amplitude. It also affects the behavior of range error (i.e. amount of error, whether it gets larger/smaller w.r.t. modulation frequency, etc.).

### Alternative Method

A good mathematical model will produce a result that is ‘close’ to the desired result in the simplest way possible. Given that the actual waveform phases approximately map onto a diamond shape, a triangular wave may be expected to yield good results.

Under the assumption that DCS frames are observations of a triangular wave, the phase equivalent can be found by:

$$r := \vert {dsc}_{3} - {dsc}_{1} \vert + \vert {dsc}_{2} - {dsc}_{0} \vert$$

$$θ = \{ \begin{matrix}3 + \frac{{dcs}_{3} - {dcs}_{1}}{r} , & {dsc}_{2} - {dsc}_{0} \geq 0 \\ 1 - \frac{{dcs}_{3} - {dcs}_{1}}{r} , & {dsc}_{2} - {dsc}_{0} < 0\end{matrix}$$

### Where θ∈[0,4].

One can designate the sin wave approximation as the “arctan 2” approach, and the one using the triangular wave approximation as the “arcdiamond2” approach. Either approach computes the amount of arclength traveled on the perimeter of its unit shape to get the point

$${r}^{- 1} ( d c {s}_{3} - d c {s}_{1} , {dcs}_{2} - d c {s}_{0} ) .$$

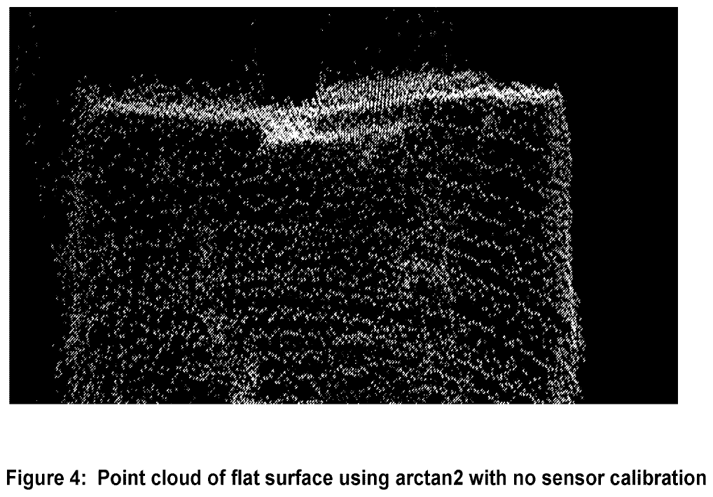

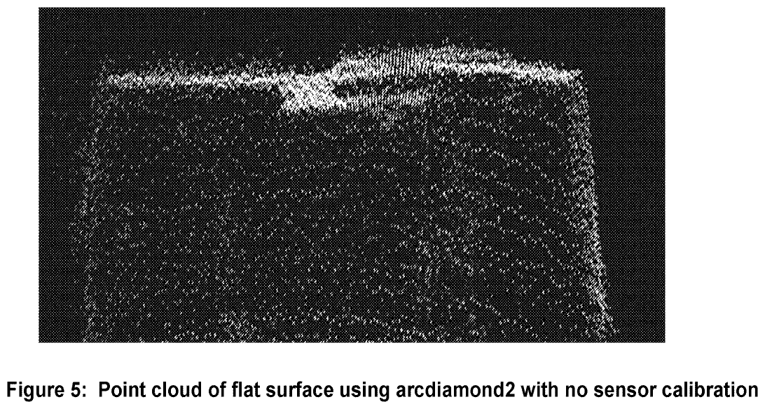

A flat surface for a point cloud calculated using arctan 2 with no sensor calibration is shown in FIG. 4, with the same object depicted using arcdiamond2 in FIG. 5. While both figures are “fuzzy” on the left side, FIG. 5 is straighter along the top

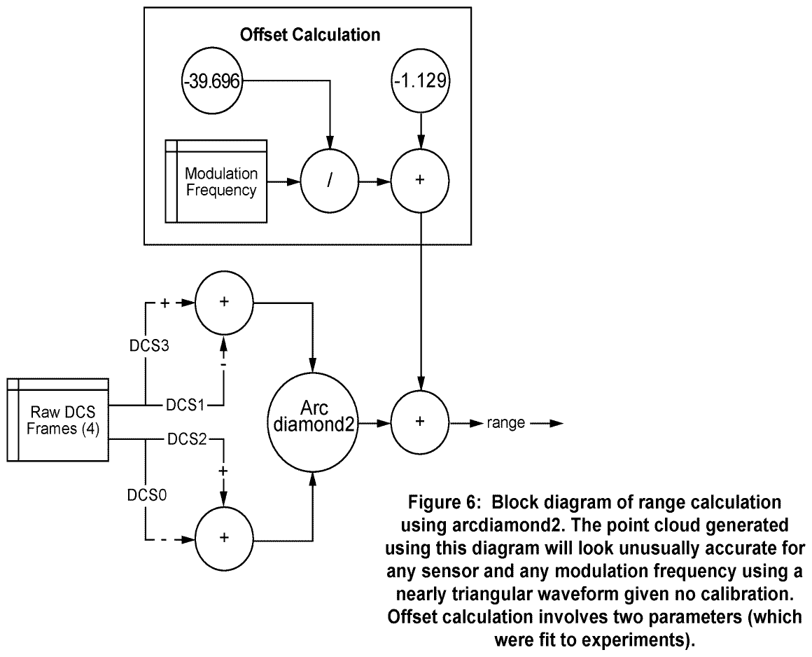

A simple model of how to compute range using the arcdiamond2 approach is outlined in FIG. 6, which shows an example block diagram of range calculation using arcdiamond2. The point cloud generated using this diagram will look unusually accurate for any sensor and any modulation frequency using a nearly triangular waveform given no calibration. Offset calculation involves two parameters (which were fit to experiments). Importantly, good results, with no calibration required can be attained by using two offset values that may be determined experimentally.

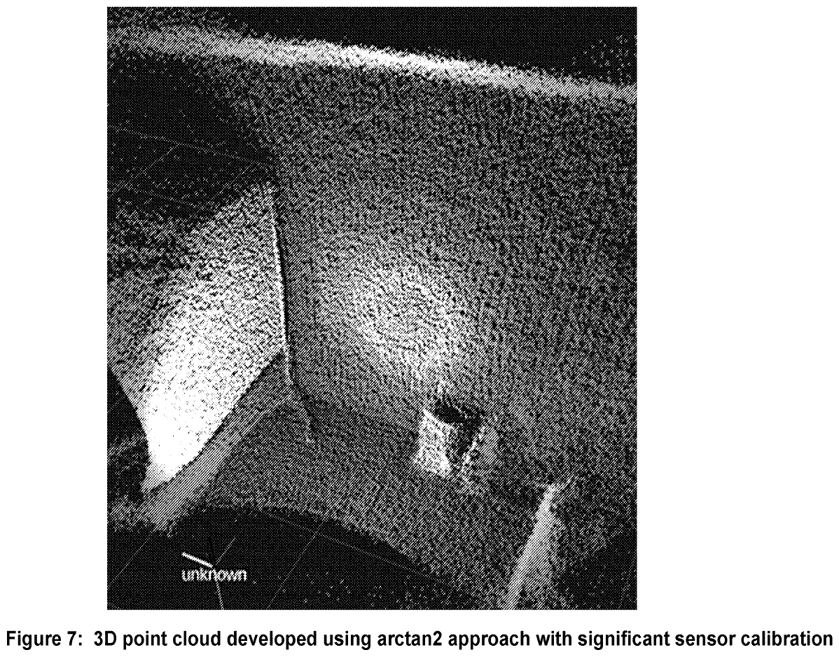

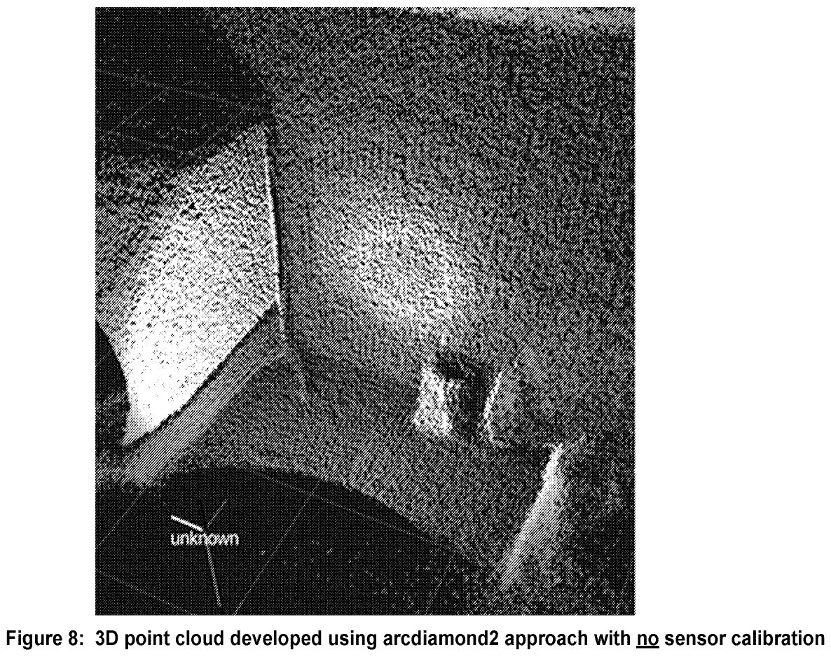

FIG. 7 shows a representative point cloud generated in the typical fashion, using the arctan 2 methodology plus significant sensor calibration adjustments as noted in FIG. 2. While FIG. 8 looks almost identical, it was generated using the arcdiamond2 methodology with no calibration adjustments, a substantial savings of computation time. In addition, the calibration adjustments required by arctan 2 are themselves generated by laborious a priori calibrations that established the lookup tables required for the adjustments.

### Benefits of Alternative

Computing arcdiamond2 is much faster than computing arctan 2 given the same computation resources, which should allow for less expensive system designs.
Arcdiamond2 is more stable than even a corrected arctan 2, eliminating much of the low frequency harmonic distortion one sees with the more common approach
Analog of amplitude is also cheaper to compute, with no need for square roots or power functions.
When implemented on an FPGA, arcdiamond2:
   Is more accurate than arctan 2 since it would not require lookup tables and the commensurate interpolations.
   Requires less bandwidth in the fabric since there is no memory access over to atan LUTs required.

### Error Analysis

This analysis is based on a mathematical model that estimates the behavior of the emitters, and is best applied in estimating general trends.

A summary of error analysis results is shown:
Without any error correction, arcdiamond2 is more accurate than arctan 2 for 12 mhz and below.
Error of arcdiamond2 and arctan 2 is primarily of the form:

$$a 1 * sin ( 4 * phase ) + a 2 * sin ( 8 * phase ) + a 3 * sin ( 12 * phase ) + …$$

Error of arctan 2 primarily in the a1*sin (4*phase) term
Error of arcdiamond2 tends to need higher orders. Error of arctan 2 needs 1 or 2 terms.
Arcdiamond2 is more accurate the lower the modulation frequency. Arctan 2 is more accurate the higher the modulation frequency.
Systematic errors of both arctan 2 and arcdiamond2 seem to be well modeled by low dimensional functions (˜2 degrees of freedom).

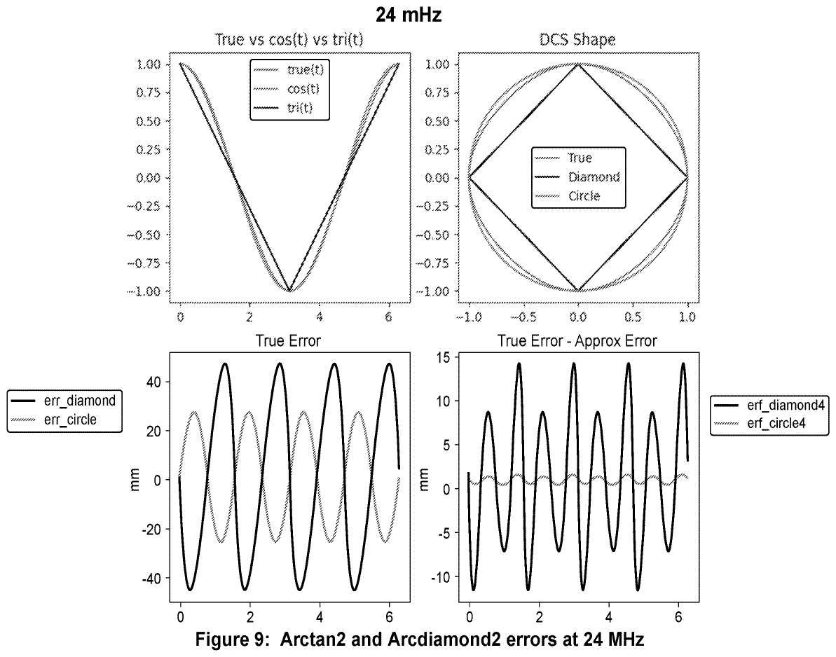

As shown in FIG. 9, Arctan 2 performs better than arcdiamond2 at 24 MHz as expected. In addition, with a single error correction term (a1*sin (4*phase),) arctan 2 performs much better than arcdiamond2.

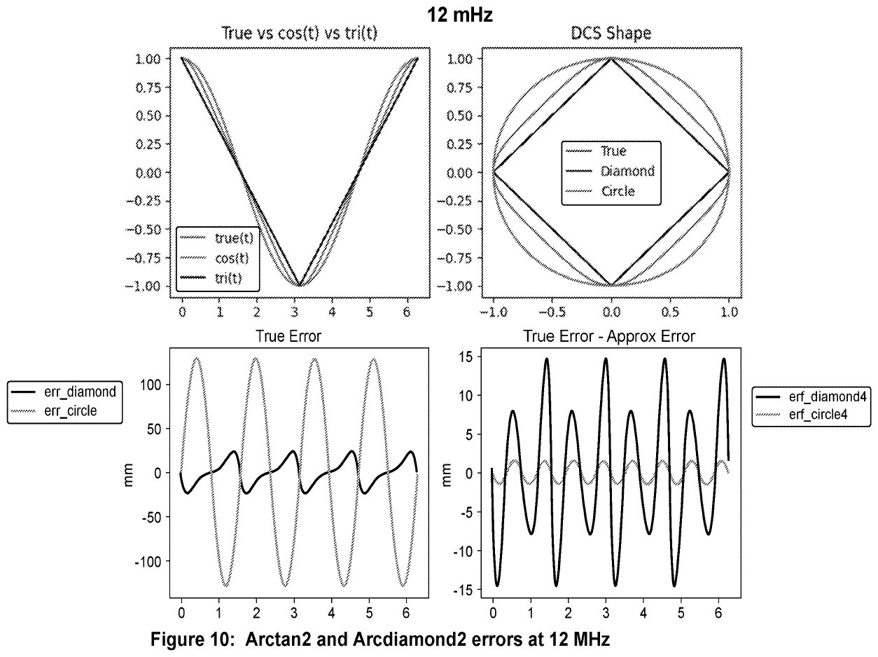

Conversely, FIG. 10 shows that arcdiamond2 outperforms arctan 2 at 12 MHz. However with a single error correction term, arctan 2 again outperforms arcdiamond2.

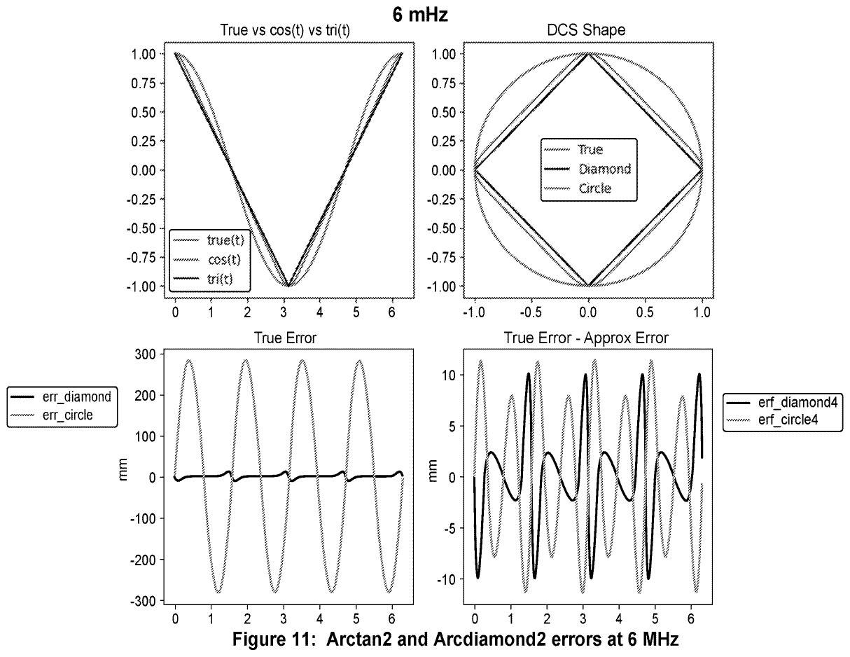

Finally, FIG. 11 shows that at 6 mhz, arcdiamond2 is much better than arctan 2, and with a single error correction term, the two are comparable.

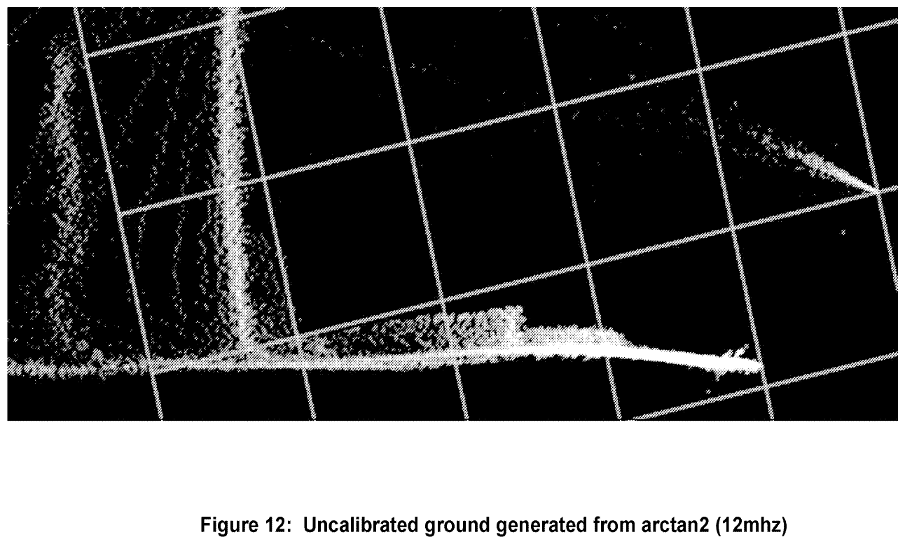

FIG. 12 shows uncalibrated ground generated from arctan 2 (12 mhz). Noticeable harmonic distortions in ground.

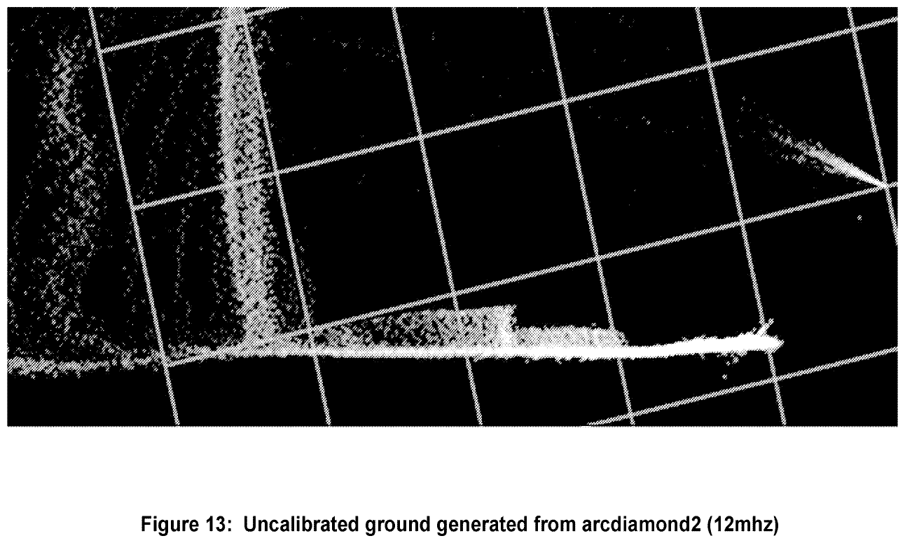

FIG. 13 shows uncalibrated ground generated from arcdiamond2. Wiggles still present, but are significantly smaller in amplitude.

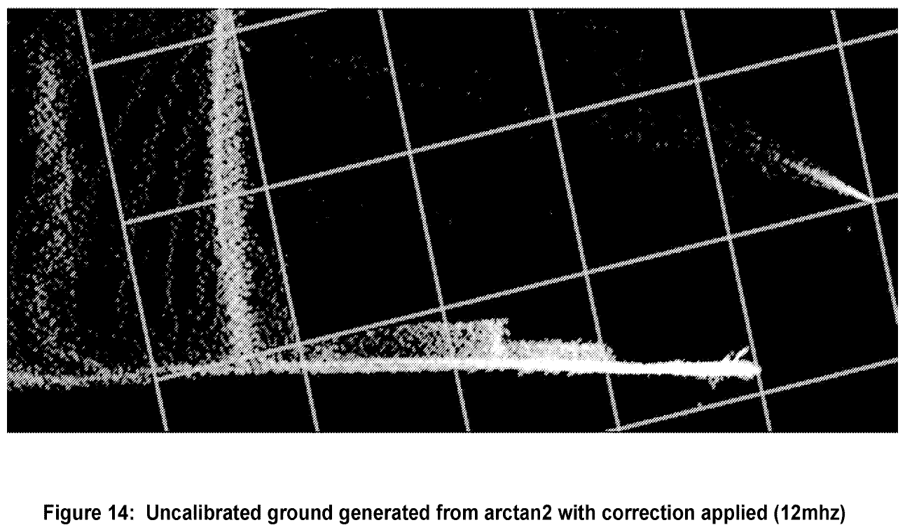

FIG. 14 shows uncalibrated ground generated from arctan 2 (12 mhz) with a single error correction term. Large amplitude wiggles are no longer visible in ground.

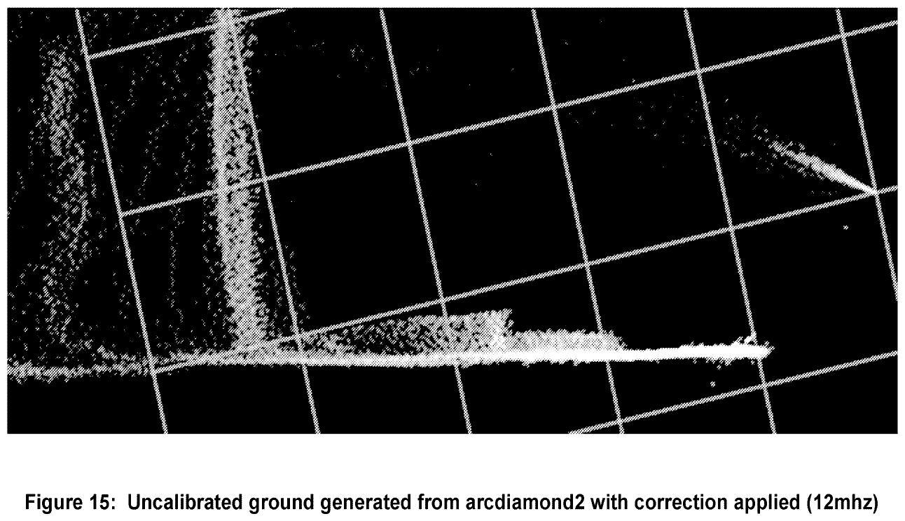

FIG. 15 shows uncalibrated ground generated from arcdiamond2 (12 mhz) with a single error correction term. Wiggles are removed from ground.

### Modulated Wave Time of Flight Method Data Collection and Refinement

Commonly assigned U.S. patent application Ser. No. 15/368,390 discloses how a carrier wave when modulated with the continuous wave can reduce environmental and electronic noise. For a SDL, the carrier wave can be updated to accommodate different kinds of keying, requiring different carrier waveforms. The data collection system can be modified to record signal to noise ratios, which then serve as feedback for determining waveform efficacy, either in real time or off-line.

It is highly advantageous to have large numbers of systems collecting data over long periods of time so as to identify “edge cases” where noise is particularly a concern, and how well different carrier waveforms reduce noise. The system can be designed to sense when a threshold or other noise characteristic is met or exceeded to then collect a short period of unmodulated noise data that can be used for further modulation waveform refinement.

### Modifying Algorithms Generating Point Clouds Based on Scene Quality Measurements

As point clouds are generated, the quality of each pixel can be assessed. Those with unusually high or low amplitudes are a particular concern, as high amplitudes may indicate saturation and low amplitudes imply insufficient information with which to calculate a valid range. An SDL can impose different algorithms to manage these cases and thus create point clouds of higher quality.

Normally, one generates a point cloud from 4 des observations in addition to 1 ambient frame. This section presents an approach for implementing a filter that updates an internal state every des frame. The methodology supports different treatment per pixel depending on its characteristics.

This is the initial model for how phase, amplitude, and ambient (denoted θ, A, amb) relate to des observations.

$$d c {s}_{k} = A cos [ f ( θ + {t}_{k} ) ] + {g}_{k} ( amb )$$

Here f,g are functions that are known (at least after calibration). A trig identity gives us:

$$d c {s}_{k} = A [ cos ( f ( θ ) ) cos ( {t}_{k} ) - sin ( f ( θ ) ) sin ( {t}_{k} ) ] + {g}_{k} ( a m b )$$

Our unknowns are θ, A, amb. We know tₖ. Combining the unknowns together into a single vector \vec{x} gives

$${x}_{1} := A cos ( f ( θ ) )$$

$${x}_{2} := Asin ( f ( θ ) )$$

$${x}_{3} := {g}_{k} ( a m b )$$

$$x := {[ {x}_{1} {x}_{2} {x}_{3} ]}^{T}$$

This x state is a linear combination of observed des states. While it is possible to apply different filters as the state is updated to reduce noise, better control saturation and control other attributes, the unfiltered des may be recovered as follows.

We can recover θ, A from the following:

$${A}^{2} = {x}_{1}^{2} + {x}_{2}^{2}$$

$$f ( θ ) = {tan}^{- 1} ( \frac{{x}_{2}}{{x}_{1}} )$$

Combining the known terms into a single vector, \vec{v}ₖ, gives:

$${v}_{k} := [ \begin{matrix}cos ( {t}_{k} ) & - sin ( {t}_{k} ) & 1\end{matrix} ]$$

$${dcs}_{k} = {v}_{k} \cdot x$$

With this approach, the phase may be calculated with just 3 observations, rather than the 4 dcs frames normally used. More importantly, once 3 dcs frames are initially received, the phase can be updated with each frame, thus greatly increased the frame rate. Conversely, an arbitrarily large number of dcs frames can be used in cases of dark pixels or areas with unusual noise levels.

### Use of DCS Frame Signal Processing to Reduce Measurement Noise

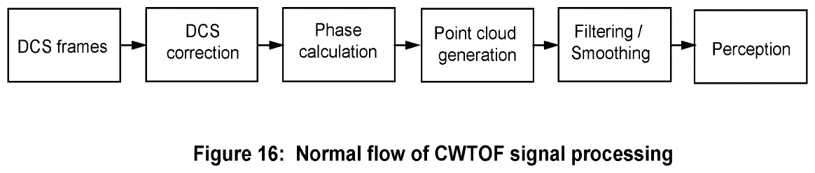

DCS frames are normally captured, processed into generate a point cloud, which is subsequently filtered and smoothed as represented in the FIG. 16 block diagram.

It is important to note that this approach performs the phase calculation before any filtering. The phase calculation involves a few numerically unstable components given low signal returns, where dcsₖ samples are small. Subtractive differences of small measurements will result in a noisy result. Additionally, dividing by the difference of two small noisy measurements, as shown in the classic arctan formulation for calculating phase shift, will be very numerically unstable.

$$f ( φ ) = {tan}^{- 1} ( \frac{d c {s}_{3} - d c {s}_{1}}{d c {s}_{2} - d c {s}_{0}} )$$

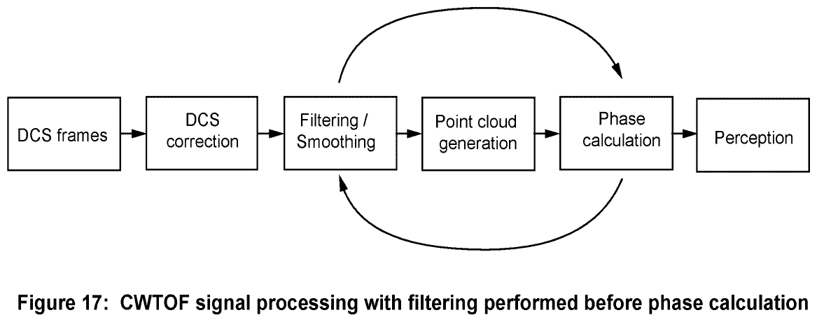

Given that information is destroyed in the phase calculation (due to numerical instability), it is beneficial to apply filtering/smoothing before this operation as shown in FIG. 17.

### Saturation Compensation Algorithms

### Introduction

A proper sensor exposure control is essential for maximizing detection range and optimizing measurement quality. If the light intensity received by any pixels exceeds their capacity, those pixels will be saturated and the reporting distance will not be accurate. On the other hand, if the light received by any pixels is too low, the distance returns will be also unreliable and thus noisy. This is especially true of sensors with relatively low dynamic range such as many CWTOF sensors.

### Non-Ideal Exposure Settings in Pre-Crash Applications

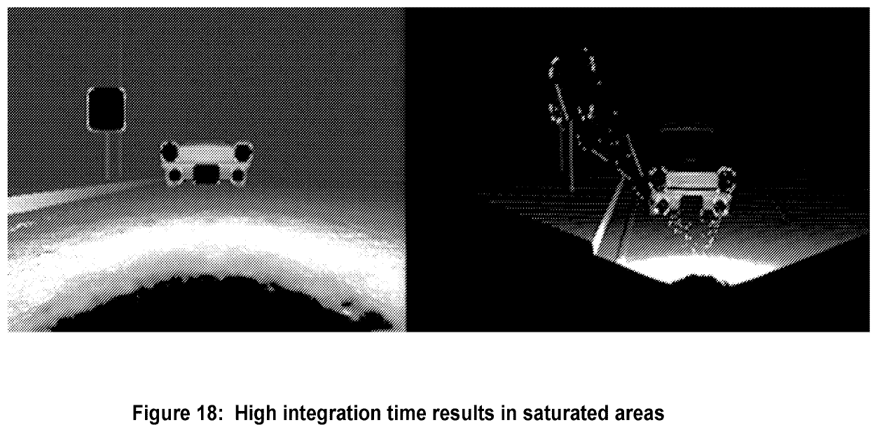

If the integration is too high in precrash scenarios, pixels on the retro-reflectors such as signs, lights, and license plates are likely to saturated and create hollow holes as shown in FIG. 18.

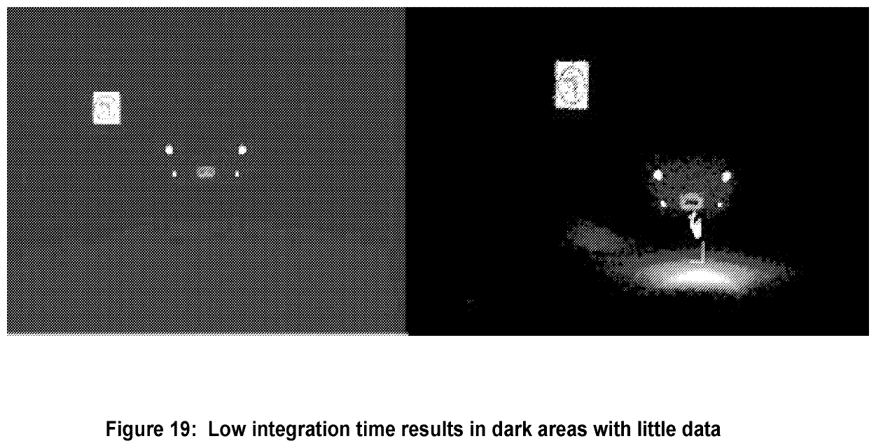

On the other hand, if the integration time is too small in precrash scenarios, pixels tends to be noisier and may introduce errors in distance and shape estimation, as FIG. 19 shows.

### Not Ideal Exposure Settings in Close-Up Views

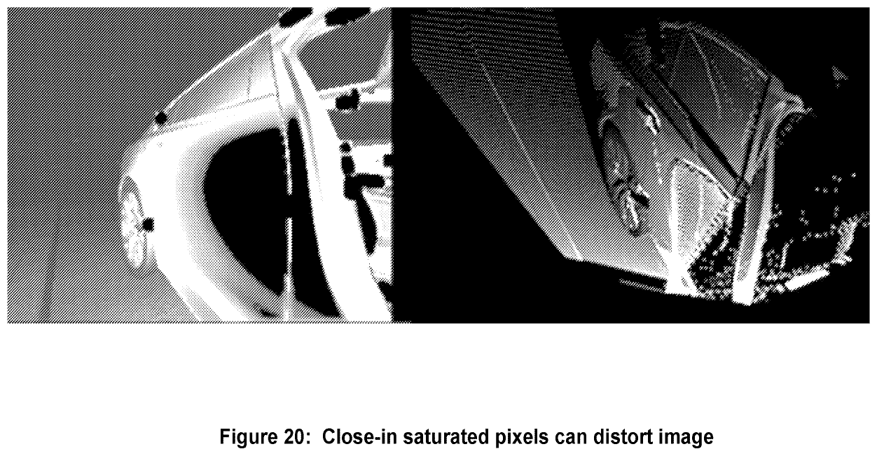

If the integration time is too high in a close-up view, some pixels may be saturated and distort the shape of the object, as shown in FIG. 20.

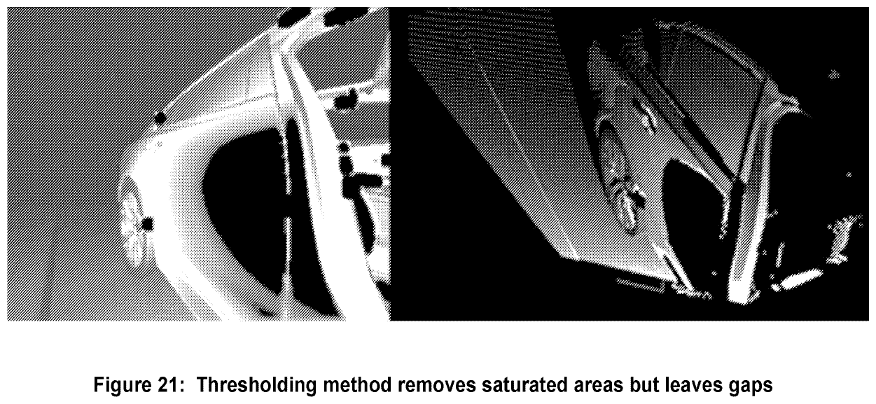

We can easily remove the saturated pixels by thresholding, but then it will create hollow spots as FIG. 21 illustrates.

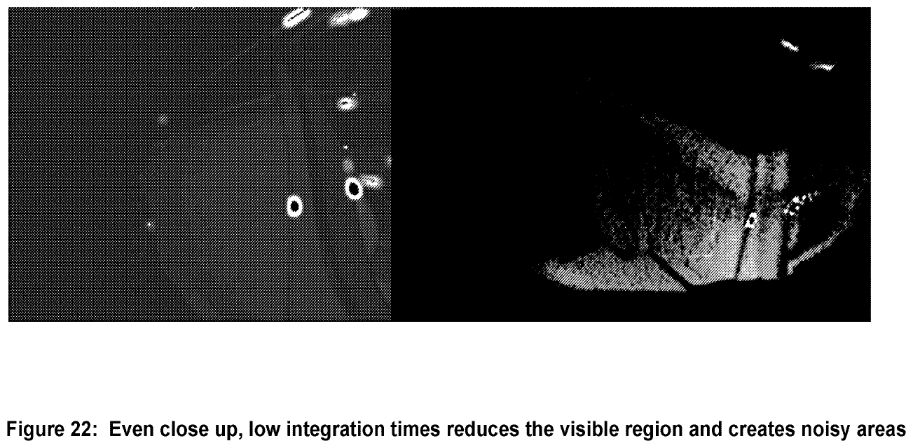

If the integration time in a close-up view is too low, the points on the objects will become noisy, and the visible region is reduced as shown in FIG. 22.

### Goals and Algorithm Requirements

Based on the assumption (and some preliminary observation from capture data) that the signal-to-noise ratio and distance accuracy increase with increasing exposure, a reasonable goal of the saturation compensation is to maximize the integration time without saturating the pixels.

To address the exposure issue, several possible methods are investigated in this report, including:
1. Pixel saturation correction
2. Dual integration time
3. Feedback control

The following section will describe the three saturation compensation methods. The pros and cons will also be discussed.

### Methods

CSIM simulation data were used for the algorithm evaluation. The CSIM simulation can be configured to run either in dual-integration mode or in on-demand mode:
dual-integration mode: the integration time of the sensor is toggled between low and high values consecutively, i.e., if the i-th frame has a low integration time, the previous and next frames must have high integration times.
on-demand mode: the integration time can be set at any frame, and it will take effect at the next frame.

The following sections describe the possible saturation correction methods:

### Pixel Saturation Correction

Pixel saturation correction algorithm processes the raw amplitude and distance images and replaces the amplitude and distance values of the saturated pixels with estimated values.

The pixel saturation correction is used to estimate information of the saturated pixels, and can be used independently or be combined with the other two integration-time control methods.

### Dual Integration Time

Dual integration time algorithm processes the current data and the cached data from the previous frame and generates the final corrected data. Since the sensor operates in the dual integration mode, any pair of adjacent frames consists of a high-integration-time frame and a low-integration-time frame. The high-integration-time frame contains data with greater strength-to-noise ratios (SNR), but it also contains some saturated pixels (which may cause significant distance errors). The missing or erroneous information of those saturated pixels can be recovered from the low-integration-time frame, because those saturated regions in the high-integration-time frame should be unsaturated and with adequate SNR in the low-integration-frame.

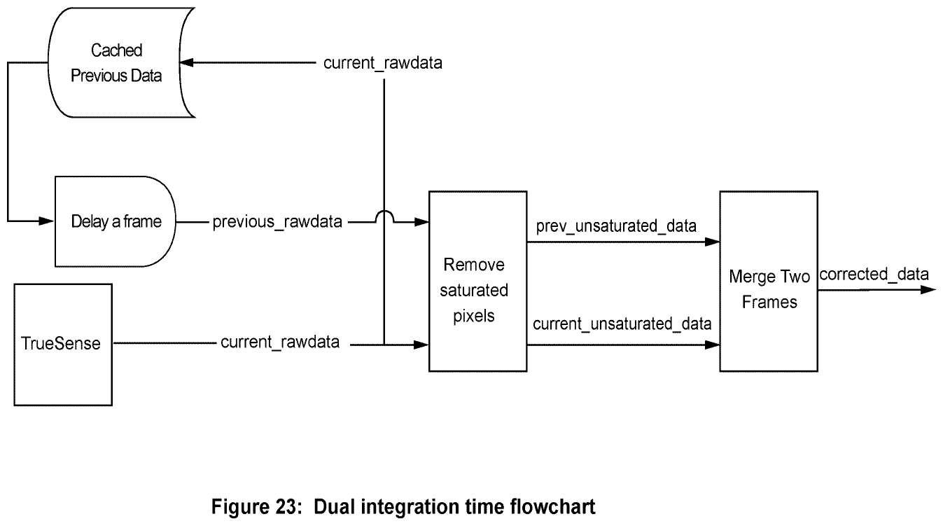

Therefore, the dual integration time algorithm shown in FIG. 23 is designed based on the reasoning above. It collects a pair of adjacent frames; removes saturated pixels in the high-integration-frame; and then merges the two frames into one. During merging, the pixels with the greater amplitudes (and thus the better SNR) between the two frames are selected to be placed in the output data.

### Feedback Control

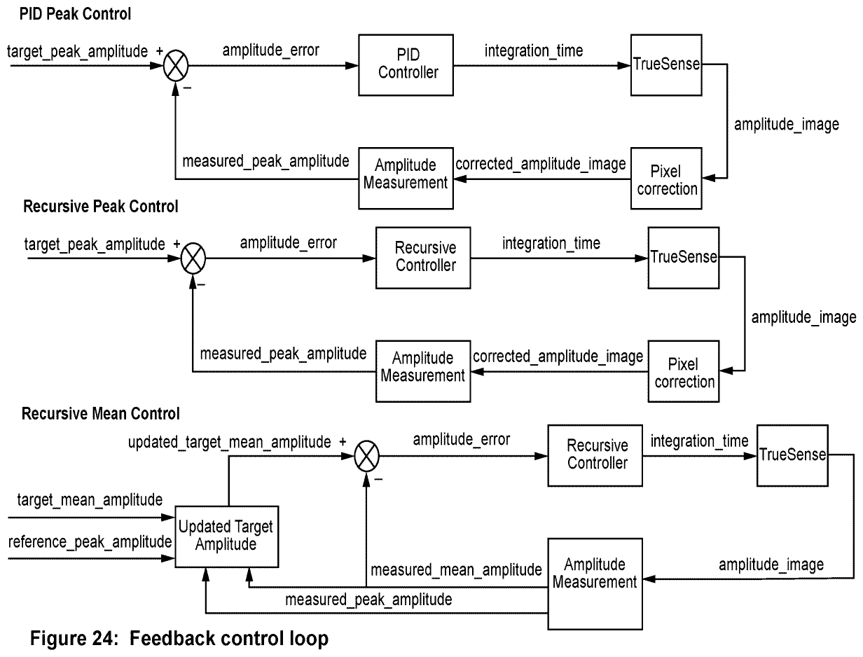

Feedback control algorithm measures a specified metric based on the amplitude data in the current frame; estimates the metric error; and calculate the integration time for the next frame. A CWTOF sensor then receives the updated integration time and continues to capture a new frame using this updated integration time. The main idea is to maintain the exposure at a high level to achieve a high SNR without saturating the image. There are several variants, and their flow diagrams are shown in FIG. 24:

### Feedback Exposure Control Under 2 Frames of Delay (Close-Up View)

The efficacy of the feedback control can be easily affected by the delay. If the new integration time does not take effect at the next frame but with some delay. The error will be accumulated and the control loop will become unstable very soon. The following video shows a delay of 2 frames makes the feedback control unstable.

The delay in the control loop can be corrected if the process model is known. However, the image intensity can change rapidly in the scene and may not be straight-forward to be modeled. Another option is to reduce the control gain, but it will make the exposure response slow. More investigations on the actual delay on the hardware is required to figure out solutions.

The following table summarizes pros and cons of the three methods:

| Methods | Pros | Cons |
|---|---|---|
| Pixel Saturation | Only needs one frame of | Only works for flat objects that |
| Correction | data | is parallel to the sensor plane |
| | | Not works for close-up objects |
| Dual Integration | No instability issue due to | Has motion artifacts (in moving |
| Time | delay | scenes) |
| Feedback | Best image quality than | Delay in the control loop may |
| Exposure Control | the other two methods | introduce instability problem |

Each method has its pros and cons, and no one is the clear winner. How to apply these methods may depend on the applications.

### Modifying Sensor Performance to Optimize Data Fusion Techniques

Sensor fusion entails combining data from two or more sensing modalities that are observing at least parts of the same scene in overlapping times. A typical sensor fusion approach is to use sensors with divergent sensing modalities (e.g. radar vs. optical). Each modality will have different strengths and weaknesses for a given application. In a precrash application, for example, radar will generally be longer range and less susceptible to weather than a near-field Lidar; however, the Lidar will have much higher resolution, faster update rates superior depth perception. SDL systems are well suited for sensor fusion techniques since the waveform can be modified to exploit the strengths and ameliorate the disadvantages of other sensor types.

A good example of this is where a flash lidar is integrated with an RGB camera. The camera runs at roughly a fifth of the frame rate as the flash lidar in this case, but it boasts a much higher resolution and is more amenable to machine vision techniques for object definition. At longer ranges, the lower resolution flash lidar gets only a few pixels on target, making it difficult to know what object the system is tracking. The RGB camera provides the object classification and location within the field of view, and the flash lidar tracks it. See U.S. Patent Application No. 63/231,479 filed Aug. 10, 2021.

As a software defined system, approach could readily be altered as different objects are defined, the range of the flash lidar increases (via waveform modifications), and as use cases evolve. For example, the lidar could be modified to provide tracking data to a radar in a high clutter environment to help it decern actual objects from multi-path shadows.

All patent applications, patent publications, and publications cited above are incorporated herein by reference for all purposes as if expressly set forth.

1. A CWTOF lidar system comprising:
a LIDAR sensor,
and
a processor and/or processing circuit connected to the LIDAR sensor, the processor and/or processing circuit configured to perform operations comprising:
applying a selectable mathematical triangular wave model to a continuous wave approach to increase accuracy and reduce calibration burden, and
modulating a carrier waveform with the selectable mathematical triangular wave model and then demodulating the carrier waveform prior to summation in order to improve noise rejection from both environmental and electronic sources.

2. The system of claim 1 wherein the operations further comprise modeling continuous waves from a CWTOF sensor using the triangular wave model to map waves onto a 3D point cloud.

3. The system of claim 2 wherein the operations further comprise requiring no calibration adjustments.

4. The system of claim 1 wherein the processor and/or processing circuit comprises a logic gate array.

5. A system of claim 1 wherein the operations further comprise calculating the phase of image sensor data using three calculations in the form:
$${v}_{k} := [ \begin{matrix}cos ( {t}_{k} ) & - sin ( {t}_{k} ) & 1\end{matrix} ]$$
$${dcs}_{k} = {v}_{k} \cdot x$$

6. The system of claim 1 wherein the operations further comprise saturation compensation using dual integration time and feedback exposure control.

7. The system of claim 1 wherein the operations further comprise modifying image sensor performance to optimize data fusion techniques including operating an image sensor at a slower frame rate than a flash lidar and using the processor and/or processing circuit to fuse the data from the image sensor and the flash lidar to increase overall resolution while providing object tracking.

8. The system of claim 1 wherein the operations further include updating differential correlation sample (DCS) frames with every sample to track faster objects.

9. The system of claim 1 wherein the operations further include performing post-collection DCS frame signal processing to significantly reduce temporal noise.

10. The system of claim 1 wherein the operations further include using alternate frames at different integration times to significantly increase the dynamic range of the system.

11. The system of claim 1 wherein the operations further include integrating data from the LIDAR sensor with data from an amplitude map from the camera to form and track objects.
